(19) United States
(12) Patent Application Publication
(10) Pub. No.: US 2006/0207810 A1
(43) Pub. Date: Sep. 21, 2006

(54) Hybrid drive

(75) Inventors: Joachim Loew, Sindelfingen (DE); Peter Saubert, Stuttgart (DE); Andreas Schondelmaier, Erdmannhausen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/527,185

(22) PCT Filed: Aug. 26, 2003
(86) PCT No.: PCT/EP03/09412

§ 371 Date: Apr. 7, 2006

(30) Foreign Application Priority Data
Sep. 13, 2002 (DE) 10242605.8

(51) Int. Cl. B60K 6/00

(52) U.S. Cl. 180/65.2

(57) ABSTRACT

The invention relates to a hybrid drive for a motor vehicle having a branching gearbox between an internal combustion engine, a generator and an electric motor which is positively coupled to the drive train for driven vehicle wheels, with the rotation speed of the drive train in each case being determined in two different ways which are asymmetrically redundant with respect to one another.

The invention relates to a hybrid drive for motor vehicles having an internal combustion engine, an electric motor, a generator and a branching gearbox which is arranged between the internal combustion engine, the generator and the electric motor, each having a gearbox connection, that is to say a gearbox input and output, for the internal combustion engine, the generator and the electric motor, which is positively coupled via a drive train to driven wheels of the motor vehicle.

DE 197 21 298 A1 discloses a hybrid drive which is intended for motor vehicles and has an electrical machine which can be connected to an internal combustion engine via a clutch or coupling, can operate both as a generator and as an electric motor, and is connected for drive purposes to the drive wheels of the vehicle via a variable ratio gearbox.

A hybrid drive of the type mentioned initially has already been proposed in order to provide very largely any desired transmission ratios between the internal combustion engine and the drive train, with the generator being loaded to different extents and with the electric motor being controlled for a different power. In this case, it is also possible to supply electrical power emitted from the system via the generator virtually directly to the electric motor, to operate the internal combustion engine and the generator at the same rotation speed, and/or to switch off the internal combustion engine while driving.

In a hybrid drive such as this, the rotation speed (nA) of the drive train is a highly important parameter for control and operational reliability of the hybrid drive.

One object of the invention is therefore to indicate possible ways to reliably determine the rotation speed (nA) of the drive train without any major design effort, to be precise even when the sensor system is faulty.

According to the invention, this object is achieved in that with the rotation speed (nA) of the drive train being determined, in order to control the hybrid drive, by means of a sensor arrangement which has separate sensors for determination of measured values of the rotation speed (nV) of the internal combustion engine, the rotation speed (nG) of the generator, the rotation speed (nE) of the electric motor, the rotation speed (nR) of predetermined driven vehicle wheels and/or the rotation speed (nR*) of further vehicle wheels, with a rotation speed which can be verified from the abovementioned measured values in at least two different ways which are asymmetrically redundant relative to one another being used as the rotation speed (nA) of the drive train.

The invention is based on the general idea of determining the rotation speed of the drive train indirectly from measured values which are available in the vehicle in any case. The rotation speeds of the internal combustion engine, the generator and the electric motor are detected in any case in order to control these units. The rotation speeds of all the vehicle wheels are normally determined for anti-lock braking systems and/or traction control systems.

According to the invention, the measured rotation speed (nE) of the electric motor can be used as the rotation speed (nA) of the drive train when a rotation speed of the electric motor (nEb) calculated from the rotation speeds of the internal combustion engine (nV) and of the generator (nG) is plausible and adequately matches the measured rotation speed of the electric motor (nE) and, furthermore, adequate matching of the measured rotation speed of the electric motor (nE) is provided with a rotation speed of the drive train (nAb) calculated from the rotation speeds (nR) of predetermined driven vehicle wheels.

This is preferably the normal method of operation.

Furthermore, the measured rotation speed of the electric motor (nE) can also be used as the rotation speed of the drive train (nA) when the rotation speed of the electric motor (nE_{b}) calculated from the rotation speeds of the internal combustion engine and the generator, as well as a rotation speed of the drive train (nA*_{b}) calculated from the rotation speeds of further vehicle wheels (nR*) are plausible, and the measured rotation speed of the electric motor (nE) adequately matches both the abovementioned calculated rotation speed of the electric motor (nE_{b}) and the abovementioned calculated rotation speed of the drive train (nA*_{b}).

In this case, provision is preferably made for a fault signal additionally to be used in order to indicate that the value of the rotation speed of the drive train (nA_{b}) calculated from the rotation speeds of predetermined driven vehicle wheels (nR) is incorrect. This fault signal can additionally or alternatively be used to no longer take account of or to no longer use the rotation speed (nA_{b}) which has been identified as being incorrect.

Furthermore, the measured rotation speed of the electric motor (nE) can be used as the rotation speed of the drive train (nA) when the measured rotation speed of the electric motor (nE) and the rotation speeds of the predetermined driven vehicle wheels (nR) are plausible and a rotation speed of the drive train (nAb) calculated from the rotation speeds of predetermined driven vehicle wheels (nR) corresponds adequately to the rotation speed of the drive train (nA*b) calculated from the rotation speeds of further vehicle wheels (nR*) and the measured rotation speed of the electric motor (nE) adequately matches the rotation speed of the drive train (nAb) calculated from the rotation speeds of predetermined driven vehicle wheels (nR).

In this case, provision should preferably be made for a fault signal additionally to be used in order to indicate that the rotation speed of the electric motor (nEb) calculated from the rotation speeds of the internal combustion engine (nV) and of the generator (nG) is incorrect. This fault signal can once again additionally or alternatively be used to no longer take account of or to no longer use the rotation speed (nEB) which has been identified as being incorrect.

Furthermore, the rotation speed of the drive train (nA_{b}) calculated from the rotation speeds of predetermined driven vehicle wheels (nR) can be used as the rotation speed of the drive train (nA) when this rotation speed adequately matches the rotation speed of the drive train (nA*_{b}) calculated from the rotation speeds of further vehicle wheels (nR*), and the rotation speed of the electric motor (nE_{b}) calculated from the rotation speeds of the internal combustion engine and the generator is plausible and, furthermore, there is no adequate match between the measured rotation speed of the electric motor (nE) and the abovementioned calculated rotation speed of the electric motor (nE_{b}), and the rotation speed of the drive train (nA_{b}) calculated from the rotation speeds of predetermined drive wheels.

The reliability of the calculated rotation speed of the drive train (nA_{b}) used for the rotation speed of the drive train (nA) can be improved further here by additionally checking whether this calculated rotation speed adequately matches the calculated rotation speed of the electric motor (nE_{b}) and/or whether the discrepancies between the measured rotation speed of the electric motor (nE) and the calculated rotation speed of the electric motor (nE_{b}), on the one hand, and between the measured rotation speed of the electric motor (nE) and the rotation speed of the drive train (nA_{b}) calculated from the rotation speeds of predetermined drive wheels, on the other hand, are of the same order of magnitude.

Apart from this, when using the rotation speed of the drive train (nA_{b}) calculated from the rotation speeds of predetermined drive wheels, a fault signal is preferably produced in order to indicate that the measured rotation speed of the electric motor (nE) is incorrect and/or must no longer be taken into account.

Finally, the rotation speed of the electric motor (nE_{b}) calculated from the rotation speeds of the internal combustion engine and the generator can be used as the rotation speed of the drive train (nA) and a fault signal combination can be produced in order to indicate that the measured rotation speed of the electric motor (nE) and the rotation speed of the drive train (nA_{b}) calculated from the rotation speeds of predetermined driven wheels of the vehicle are incorrect and/or must no longer be taken into account when the rotation speed of the electric motor (nE_{b}) calculated from the rotation speeds of the generator and the electric motor as well as the rotation speed of the drive train (nA*_{b}) calculated from the rotation speeds of further vehicle wheels are plausible and adequately match one another, while the rotation speed of the drive train (nA_{b}) calculated from the rotation speeds of predetermined drive wheels is not plausible and there is no match between the measured rotation speed of the electric motor (nE_{b}) and the calculated rotation speed of the electric motor (nE_{b}) and/or the rotation speed of the drive train (nA*_{b}) calculated from the rotation speeds of further vehicle wheels.

A further aspect of the invention, which is fundamentally independent of the determination of the rotation speed of the drive train, makes it possible to provide for the generator and the electric motor to be controllable by means of a control arrangement as a function of a nominal/actual value comparison of the ratio of the rotation speeds of the internal combustion engine and the drive train.

This implements the general idea of using control actions on the electric motor and on the generator to allow the branching gearbox to be used as an infinitely variable transmission gearbox between the internal combustion engine and the drive train.

In this context, it may be advantageous to have the capability to switch the electric motor to the generator mode and/or the generator to the motor mode.

Apart from this, with regard to preferred features of the invention, reference is made to the claims and to the following explanation of the drawing, on the basis of which one particularly preferred embodiment of the invention will be described in more detail.

In the figures:

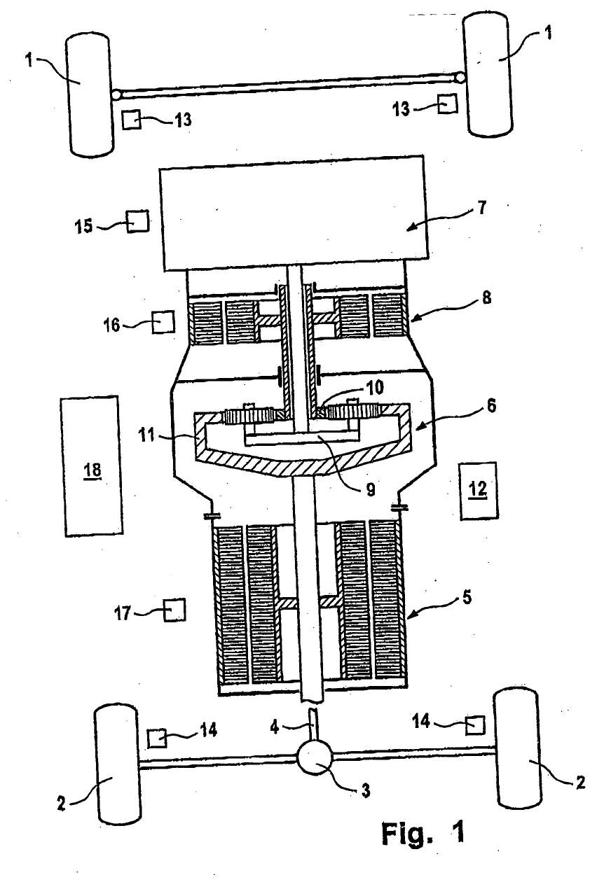

FIG. 1 shows a schematic illustration of a vehicle with a hybrid drive of the type mentioned initially, and

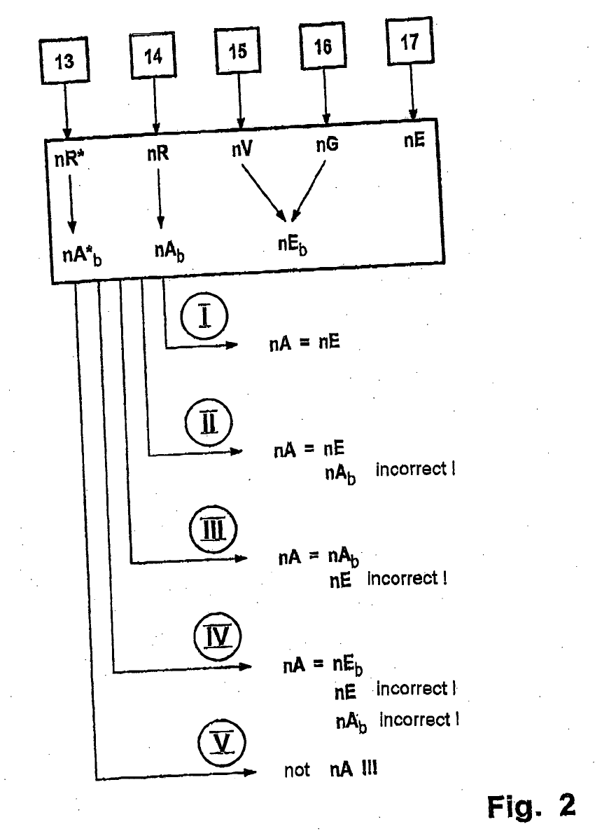

FIG. 2 shows a schematic flowchart for checking the plausibility and determining the rotation speed (nA) of the drive train, with this rotation speed representing the rotation speed of a universally jointed shaft in the illustrated example.

According to FIG. 1, a motor vehicle which is not illustrated in any more detail has non-driven steerable front wheels 1 and driven rear wheels 2.

The rear wheels are coupled for drive purposes in a fundamentally known manner via an axle differential 3 to a universally jointed shaft 4, which is itself connected for drive purposes to the motor shaft of an electric motor 5. The electric motor 5 is connected for drive purposes via an epicyclic gearbox 6, which is in the form of a branching gearbox, to an internal combustion engine 7 and to a generator 8, with the engine shaft of the internal combustion engine 7 being connected, such that they rotate together, to the planet carrier 9, with the shaft of the generator 8, which is coaxial with the engine shaft of the internal combustion engine 7, being connected, such that they rotate together, to the sun wheel 10 of the epicyclic gearbox, and with the motor shaft of the electric motor 5 being connected, such that they rotate together, to the annular gear 11 of the epicyclic gearbox.

The electric motor 5 and the generator 8 are electrically connected to a battery 12 via rectifiers and inverters, which are not illustrated.

The front wheels 1 have associated rotation speed sensors 13, and the rear wheels 2 have associated rotation speed sensors 14. The rotation speeds of the internal combustion engine 7, of the generator 8 and of the electric motor 5 are detected by means of rotation speed sensors 15 to 17.

The output of an electronic control apparatus 18 is connected to the internal combustion engine 7, to the generator 8 and to the electric motor 5 in order to control them. The input of the controller 18 is connected to the rotation speed sensors 13 to 17. Furthermore, the input of the controller 18 is connected to further sensors, which are not illustrated but which, in particular, register the state of control elements, for example the gas pedal and the brake pedal, which are operated by the driver, and thus “signal” to the controller 18 the traction power desired by the driver. Furthermore, the further sensors can also detect parameters relating to the roadway, in particular its upward or downward gradient, as well as further operating parameters relating to the internal combustion engine 7.

As shown in FIG. 2, the controller 18 receives from the rotation sensors 13 signals which reflect the rotation speed nR* of the front wheels 1. The controller 18 receives from the rotation sensors 14 signals relating to the rotation speeds nR of the driven rear wheels 2. The rotation sensors 15 to 17 transmit the rotation speeds nV, nG and nE of the internal combustion engine 7, of the generator 8 and of the electric motor 5, respectively.

The controller 18 can check all of these signals for plausibility, using preferred criteria.

By taking account of the transmission ratios of the epicyclic gearbox 6, the controller 18 can use the rotation speeds nV and nG, transmitted from the rotation sensors 15 and 16, of the internal combustion engine 7 and of the generator 8, respectively, to determine a calculated rotation speed nE_{b} of the electric motor 5. Furthermore, the controller 18 can use the rotation speeds nR of the rear wheels 2, as determined by the rotation sensors 14, and taking account of the transmission ratios of the differential 3 to determine a calculated rotation speed nA_{b} of the universally jointed shaft 4. Finally, provided that the wheels 1 and 2 are rolling essentially without skidding, the controller 18 can also use the rotation speeds nR* of the front wheels detected by the rotation sensors 13 to calculate a rotation speed nA*_{b} for the rotation speed of the universally jointed shaft 4 and of the drive train.

In addition, all of the abovementioned calculated rotation speeds nE_{b}, nA_{b} and nA*_{b} can be checked for plausibility using predetermined criteria.

The controller 18 uses the information available to it to determine the rotation speed nA of the drive train.

If the rotation speed nE_{b}, calculated from the rotation speeds of the internal combustion engine and the generator, of the electric motor is plausible, and the rotation speed nE of the electric motor 5, measured by the rotation speed sensor 17, matches the calculated rotation speed nE_{b} of the electric motor 5 and matches the rotation speed nA_{b} of the drive train calculated from the rotation speeds nR of the rear wheels 2 within a predetermined tolerance, then, in accordance with item I in FIG. 2:
nA=nE

According to Item II in FIG. 2,
nA=nE
is likewise set for the rotation speed of the drive train to be determined when the rotation speed nA_{b} of the drive train calculated from the rotation speeds of the driven rear wheels 2 does not match the rotation speed nA*_{b} determined from the rotation speeds nR* of the front wheels 1, but the calculated rotation speeds nE_{b} and nA*_{b} are plausible and the rotation speed nE of the electric motor 5 measured by the rotation sensor 17 matches, within a predetermined tolerance, the calculated value nE_{b} of the rotation speed of the electric motor and the rotation speed nA*_{b} of the drive train determined by calculation from the rotation speeds of the front wheels.

Furthermore, in this case, a fault signal is preferably produced in order to indicate that the rotation speed nA_{b} of the drive train calculated from the rotation speeds of the rear wheels is incorrect.

According to Item III in FIG. 2,
nA=nA_{b}
is set when there is no adequate matching between the rotation speed nE of the electric motor 5 measured by the rotation speed sensors 17 and the rotation speed nE_{b} of the electric motor calculated from the rotation speeds of the internal combustion engine and the generator, as a well as the rotation speed nA_{b} of the drive train calculated from the rotation speeds of the rear wheels, but the calculated rotation speed nE_{b} of the electric motor 5 is plausible and, in particular, adequately matches the rotation speeds nA_{b} and nA*_{b} calculated from the rotation speeds of the front and rear wheels.

In this case, a fault signal is preferably produced in order to indicate that the measured rotation speed nE of the electric motor 5 is incorrect.

According to Item IV in FIG. 2,
nA=nE_{b}
is set when the rotation speeds nA_{b} and nA*_{b} determined from the rotation speeds of the rear wheels and from the rotation speeds of the front wheels do not adequately match and the rotation speed nE of the electric motor 5 measured by the rotation sensor 17 does not adequately match the calculated rotation speed nE_{b} of the electric motor and the rotation speed nA*_{b} calculated from the rotation speeds of the front wheels, although both the calculated rotation speed nE_{b} of the electric motor and the rotation speed nA*_{b}, calculated from the rotation speeds of the front wheels, of the drive train are plausible and there is an adequate match between the calculated rotation speeds nE_{b} and nA*_{b}.

In this situation, two fault signals are preferably emitted in order to indicate that the measured rotation speed nE of the electric motor and the rotation speed nA_{b}, calculated from the rotation speeds of the rear wheels, of the drive train are incorrect.

If the rotation speed nA of the drive train cannot be determined in accordance with Items I to IV, an emergency signal is produced in accordance with Item V in FIG. 2 in order to indicate that nA cannot be determined and that it is not possible to ensure a reliable operating state. In a situation such as this, provision is preferably made for the controller 18 to immediately switch off the internal combustion engine 7 and the electric motor 5.

Provided that the rotation speed nA of the drive train can be determined, the controller 18 can take appropriate control actions on the generator 8 and on the electric motor 5 to produce virtually any desired transmission ratios between the rotation speeds nV of the internal combustion engine and the rotation speeds nR of the driven vehicle wheels 2, that is to say the branching or epicyclic gearbox 6 and the electric motor 5 as well as the generator 8 functionally interact with one another as if a gearbox with an infinitely variable transmission ratio were arranged between the internal combustion engine 7 and the driven vehicle wheels 2.

The respective transmission ratio between the internal combustion engine 7 and the drive wheels 2 can in principle be controlled by a nominal/actual value comparison, in which case the nominal value of the transmission ratio can be determined as a function of operating parameters, for example as a function of the position of control elements which are operated by the driver, in particular such as the gas pedal or the brake pedal, and as a function of signals produced by sensors for roadway conditions, such as upward or downward gradients.

In this context, it may be advantageous to also have the capability to switch the electric motor 5 to the generator mode, and the generator 8 to the electric motor mode, as well.

If a check is carried out during the process of determining the rotation speeds as described above to determine whether rotation speeds determined in different ways adequately match one another, tolerances are preferably predetermined, whose magnitudes rise as the rotation speeds increase.

The invention is not restricted to a hybrid drive having a single electric motor 5 which is positively coupled to the universally jointed shaft 4. Instead of this, it is also possible to provide electric motors which are positively coupled to the drive wheels 2 and/or are arranged on the axle shafts of these wheels 2. In this case, the rotation speed nE is replaced by:
nE=i(nE₁+nE₂), where
i is the transmission ratio of the differential and nE₁ as well as nE₂ are the rotation speeds of the electric motors associated with the wheels 2.

### LIST OF REFERENCE SYMBOLS

1 Front wheels
2 Rear wheels
3 Differential
4 Universally jointed shaft
5 Electric motor
6 Epicyclic gearbox
7 Internal combustion engine
8 Generator
9 Planet carrier
10 Sun wheel
11 Annular gear
12 Battery
13 Rotation speed sensor
14 Rotation speed sensor
15 Rotation speed sensor
16 Rotation speed sensor
17 Rotation speed sensor
18 Open-loop or closed-loop control
nA Verified rotation speed of the drive train
nE Measured rotation speed of the electric motor (5)
nG Measured rotation speed of the generator (8)
nV Measured rotation speed of the internal combustion engine (7)
nR Measured rotation speed of the rear wheels (2)
nR* Measured rotation speed of the front wheels
nE_{b} Rotation speed of the electric motor (5) calculated from nG and nV
nA_{b} Rotation speed of the drive train/of the universally jointed shaft (4) calculated from nR
nA*_{b} Rotation speed of the drive train/of the universally jointed shaft (4) calculated from nR*

1. A hybrid drive for motor vehicles having an internal combustion engine, an electric motor, a generator and a branching gearbox which is arranged between the internal combustion engine, the generator and the electric motor, each having a gearbox connection, that is to say a gearbox input and output, for the internal combustion engine, the generator and the electric motor, which is positively coupled via a drive train to driven wheels of the motor vehicle, with the rotation speed (nA) of the drive train being determined, in order to control the hybrid drive, by means of a sensor arrangement which has separate sensors for determination of measured values of the rotation speed (nV) of the internal combustion engine, the rotation speed (nG) of the generator, the rotation speed (nE) of the electric motor, and at least one of the rotation speed (nR) of predetermined driven vehicle wheels and the rotation speed (nR*) of further vehicle wheels, with a rotation speed which can be verified from the abovementioned measured values in at least two different ways which are asymmetrically redundant relative to one another being used as the rotation speed (nA) of the drive train.

2. The hybrid drive as claimed in claim 1, wherein a measured rotation speed (nE) of the electric motor is used as the rotation speed (nA) when a rotation speed of the electric motor (nE_{b}) calculated from the rotation speeds of the internal combustion engine (nV) and of the generator (nG) is plausible and adequately matches the measured rotation speed of the electric motor (nE) and, furthermore, adequate matching of the measured rotation speed of the electric motor (nE) is provided with a rotation speed of the drive train (nA_{b}) calculated from the rotation speeds (nR) of predetermined driven vehicle wheels.

3. The hybrid drive as claimed in claim 1, wherein a measured rotation speed of the electric motor (nE) is used as the rotation speed of the drive train (nA) when a rotation speed of the electric motor (nE_{b}) calculated from the rotation speeds of the internal combustion engine and the generator, as well as a rotation speed of the drive train (nA*_{b}) calculated from the rotation speeds of further vehicle wheels are plausible, and the measured rotation speed of the electric motor (nE) adequately matches both the abovementioned calculated rotation speed of the electric motor (nE_{b}) and the abovementioned calculated rotation speed of the drive train (nA*_{b}).

4. The hybrid drive as claimed in claim 2, wherein a fault signal is additionally produced in order to indicate that the value of the rotation speed of the drive train (nA_{b}) calculated from the rotation speeds of predetermined driven vehicle wheels is incorrect.

5. The hybrid drive as claimed in claim 1, wherein a rotation speed of the drive train (nA_{b}) calculated from the rotation speeds of predetermined driven vehicle wheels is used as the rotation speed of the drive train (nA) when this rotation speed adequately matches a rotation speed of the drive train (nA*_{b}) calculated from the rotation speeds of further vehicle wheels, and a rotation speed of the electric motor (nE_{b}) calculated from the rotation speeds of the internal combustion engine and the generator is plausible and, furthermore, there is no adequate match between the measured rotation speed of the electric motor (nE) and a rotation speed of the electric motor (nE_{b}) calculated from the rotation speeds of the internal combustion engine and the generator, and a rotation speed of the drive train (nA_{b}) calculated from the rotation speeds of predetermined drive wheels.

6. The hybrid drive as claimed in claim 5, wherein a fault signal is produced in order to indicate that the measured rotation speed of the electric motor (nE) is incorrect.

7. The hybrid drive as claimed in claim 1, wherein a rotation speed of the electric motor (nE_{b}) calculated from the rotation speeds of the internal combustion engine and the generator is used as the rotation speed of the drive train (nA) when the calculated rotation speed of the electric motor (nE_{b}) as well as a rotation speed of the drive train (nA*_{b}) calculated from the rotation speeds of further vehicle wheels are plausible and adequately match one another, but a rotation speed of the drive train (nA_{b}) calculated from the rotation speeds of predetermined drive wheels is at least one of not plausible and there is no match between a measured rotation speed of the electric motor (nE) and at least one of the calculated rotation speed of the electric motor (nE_{b}) and the rotation speed of the drive train (nA*_{b}) calculated from the rotation speeds of further vehicle wheels.

8. The hybrid drive as claimed in claim 7, wherein fault signals are produced in order to indicate that the measured rotation speed of the electric motor (nE) as well as the rotation speed of the drive train (nA_{b}) calculated from the rotation speeds of predetermined driven wheels of the vehicle are incorrect.

9. The hybrid drive as claimed in claim 1, wherein, if there is no verification of the rotation speed to be determined for the drive train (nA), an emergency signal is produced and/or the internal combustion engine (7) and the electric motor (5) are/is stopped.

10.-14. (canceled)

15. A hybrid drive for motor vehicles having an internal combustion engine, an electric motor, a generator and a branching gearbox which is arranged between the internal combustion engine, the generator and the electric motor, each having a gearbox connection including an input and output for the internal combustion engine, the generator and the electric motor, wherein said gearbox connection is positively coupled via a drive train to driven wheels of the motor vehicle and wherein the generator and the electric motor are controlled by a control arrangement as a function of one of a nominal and actual value comparison of a ratio of rotation speeds of the internal combustion engine and rotation speeds of the drive train and of the driven wheels, respectively.

16. The hybrid drive as claimed in claim 15, wherein the nominal value is predetermined on a parametric basis.

17. The hybrid drive as claimed in claim 16, wherein the parametric basis is a function of at least one of positions of control elements operated by the driver and signals from a sensor system which detects parameters of a roadway.

18. The hybrid drive as claimed in claim 16, wherein the positions of control elements include at least one of a gas pedal and a brake pedal.

19. The hybrid drive as claimed in claim 16, wherein the signals from a sensor system which detects parameters of a roadway include upward and downward gradients.
